(19) United States
(12) Patent Application Publication
(10) Pub. No.: US 2016/0066559 A1
(43) Pub. Date: Mar. 10, 2016

(54) APPARATUS AND METHOD FOR USING UV LIGHT TO REDUCE COLLISIONS WITH ANIMALS

(71) Applicant: DAVID F. RUSSELL, RALEIGH, NC (US)

(72) Inventor: DAVID F. RUSSELL, RALEIGH, NC (US)

(21) Appl. No.: 14/850,641

(22) Filed: Sep. 10, 2015

Related U.S. Application Data
(60) Provisional application No. 62/048,467, filed on Sep. 10, 2014.

(51) Int. Cl. A01M 29/10; B60Q 1/28

(52) U.S. Cl. CPC A01M 29/10; B60Q 1/28

(57) ABSTRACT

The ability to see in the UV spectrum sets deer and animal vision apart from humans. Because of the absence of red cones, the drop off in sensitivity at the long-wavelength end of the spectrum occurs at shorter wavelengths for deer. They are less sensitive in the spectral region that appears orange to humans and are virtually insensitive to deep reds. Deer are much more sensitive than humans to the shorter wavelengths of light. They have been found to have a blue cone with peak sensitivity at 455 nm. 440 nm light is seen as bright blue in the dichromatic eye of the deer. The present invention involves connecting UV lights with a power source associated with the moving device, such as the device's electrical system, in such a manner that the UV lights are active whenever the device is running. Because the UV light is particularly visible and bright as seen by deer and other animals, the present invention will alert such animals that are in the path of the oncoming moving device sooner than conventional lights or other warning devices. Thus, giving the animals more chance to move out of the way in reducing collisions.

This application is based upon and claims priority from U.S. Provisional application Ser. No. 62/048,467 which is incorporated herein by reference.

### BACKGROUND OF THE INVENTION

1. Field of the Invention

Applicants' invention relates to a device for reducing the likelihood of animal collisions with motorized vehicles and other moving devices (windmills, etc.). and method for same. More particularly, it relates to repelling animals via the use of a UV light/strobe/paint mounted on or applied to mechanical or electrical devices.

2. Background Information

It is estimated that each year there are approximately 1.5 million deer/vehicle collisions that occur in the United States. Current techniques for preventing or mitigating deer-vehicle collision are sonic whistle based and have been deemed by many police departments as ineffective.

Ultraviolet (UV) light has wavelengths in the range of 100 nanometers (nm) to 400 nm. These wavelengths are shorter than what humans see as visible light (400 nm to 700 nm), but longer than X-rays (0.01 nm to 10 nm).

In most vertebrates, the eye works by allowing light to enter and then projecting it onto the retina, a light-sensitive panel of cells at the rear of the eye. The retina's cone cells, which provide the ability to distinguish color and see detailed focus, and rod cells, which provide low-light contrast, detect light and convert it to neural signals that are transmitted to the brain by the optic nerve.

People have “trichromatic” vision in which there are three (3) types of cone cells in the eye—one type that's sensitive to short-wavelength light in the blue portion of the color spectrum, a second type that is sensitive to middle-wavelength light in the green portion, and a third type that is receptive to long-wavelength light in the red portion. Human light sensitivity generally ranges from 400 nm to 700 nm.

Deer see slightly differently than humans do. A deer's color vision is based upon two types of cones, the shorter and middle wavelengths. This is called “dichromatic” vision. Deer, and most game animals, have light sensitivity in the approximate range of below 320 nm to 640 nm. This means that they cannot “see” red or green, but can see UV (ultraviolet). Thus, what appears to humans to be the very bright, blaze orange is seen as possibly a dullish yellow by deer. Conversely, a deer's ability to see light at lower spectra mean they can see UV-blue light that is virtually invisible to humans, possibly better than humans see blaze orange.

The ability to see in the UV spectrum, truly sets deer and animal vision apart from humans. UV light is generally damaging to eyes, particularly in the long-term. Thus, human eyes have colored pigment that help filter UV light. Deer have no such filter and see well in the UV spectrum. UV light—invisible to humans—can literally glow to deer.

The region of highest sensitivity for the deer is at a shorter wavelength than that of humans. The relative sensitivity of deer to short-wavelength light is dramatically higher than human sensitivity to those wavelengths. For equal intensities, deer are expected to see short and middle-wavelengths as brightest. Because of the absence of red cones, the drop off in sensitivity at the long-wavelength end of the spectrum occurs at shorter wavelengths for deer. They are less sensitive in the spectral region that appears orange to humans and are virtually insensitive to deep reds. With only two classes of cone photoreceptors, deer can distinguish no more than two basic colors, one for the short wavelength end of the spectrum and another for the middle-to-long wavelength end of the spectrum. Animals with dichromatic color vision do not see an intermediate color in the spectral region between the two colors. That is, they do not see a color that appears bluish-yellow. Instead they see the intermediate spectral region as colorless (gray). Deer are much more sensitive than humans to the shorter wavelengths of light. They have been found to have a blue cone with peak sensitivity at 455 nm. 440 nm light is seen as bright blue in the dichromatic eye of the deer. In very low light the deer, like a human, switches to rod (black, white, and gray) vision and the 440 nm light is seen by the deer as a much brighter gray.

While deer are generally used as the example herein, it is anticipated that the present invention would be effective against all animals with vision in the UV spectrum.

### SUMMARY OF THE INVENTION

The present invention takes advantage of the ability of deer and other animals to see in the UV spectrum. The method of the present invention requires the application of a UV source to a moving device.

In order to make moving devices (“moving device,” as used herein, is intended to describe any moving device including, but not limited to cars, trucks, trains, motorcycles, and windmills) more visible to animals and, therefore, reduce collisions, the current invention involves the application of a UV source, which could be lights, strobes, paint, dyes, appliques, or other manner of projecting in the UV spectrum of 100 nm to 400 nm, to illuminate the device or project UV light from the device. Further, due to the sensitivity of the animals eyes, the light source could generate light up to 600 nm. It is anticipated that, where applicable, UV lights could be connected with a power source associated with the moving device, such as the device's electrical system, in such a manner that the UV lights are active whenever the device is running.

Because the UV light in the range of 320 nm to 400 nm is particularly visible and bright as seen by deer and other animals but not generally visible to humans, the present invention will alert such animals that are in the path of the oncoming moving device sooner than conventional lights or other warning devices. Thus, giving the animals more chance to move out of the way in reducing collisions.

The method of use of the present invention involves attaching one or more of the UV sources to the front or leading edge of a moving device such as a motor vehicle. And then, if the UV source is powered, turning the power to the UV source on while the moving device is moving.

### BRIEF DESCRIPTION OF THE DRAWINGS

FIG. 1 is a perspective view of a motor vehicle without the present invention.

FIG. 2 is a perspective view of a first embodiment of the present invention.

FIG. 3 is a perspective view of a second embodiment of the present invention.

### DETAILED DESCRIPTION OF THE PREFERRED EMBODIMENT

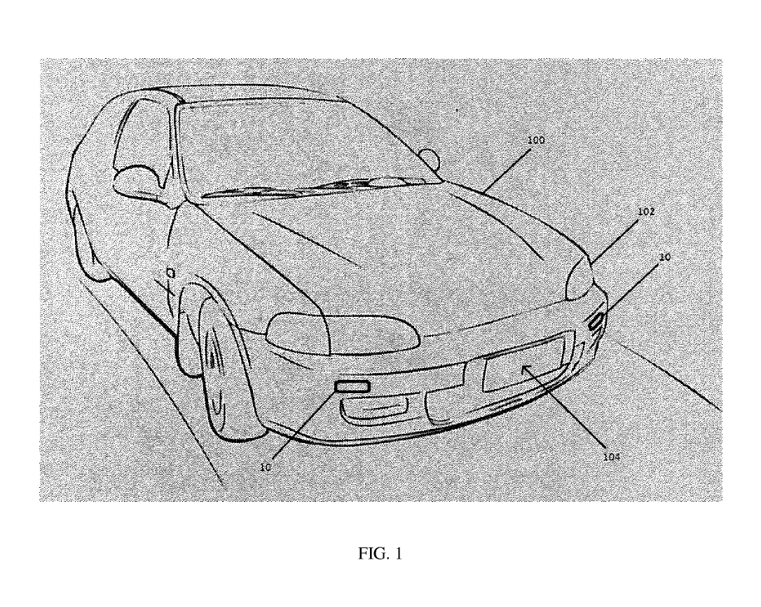

Referring to the figures, FIG. 1 illustrates a darkened motor vehicle as might be found at night. A moving device 100, such as a motor vehicle, may be less likely to be seen by animals such as deer in twilight or nighttime hours. While many moving devices are equipped with standard headlamps 102, a light source that is focused around the wavelengths seen best by deer will be more effective at alerting the animals to oncoming moving devices. While it is anticipated that most “moving devices” 100 will be motor vehicles however other moving devices could be such things as electric carts, bicycles, windmill blades, and the like. It is anticipated, that the moving device 100 will be equipped with a UV source 10 on or near the leading edge 104 of the moving device 100. The leading edge 104 is determined by the direction of travel of the moving device 100. Thus, in the case of the moving device 100 being a motor vehicle and be able to travel in forward and reverse directions the UV source 10 would generally be placed on the front 104 of the motor vehicle 100 because forward it is the standard direction of travel. However, a UV source 10 could be placed on any side of the moving device 100.

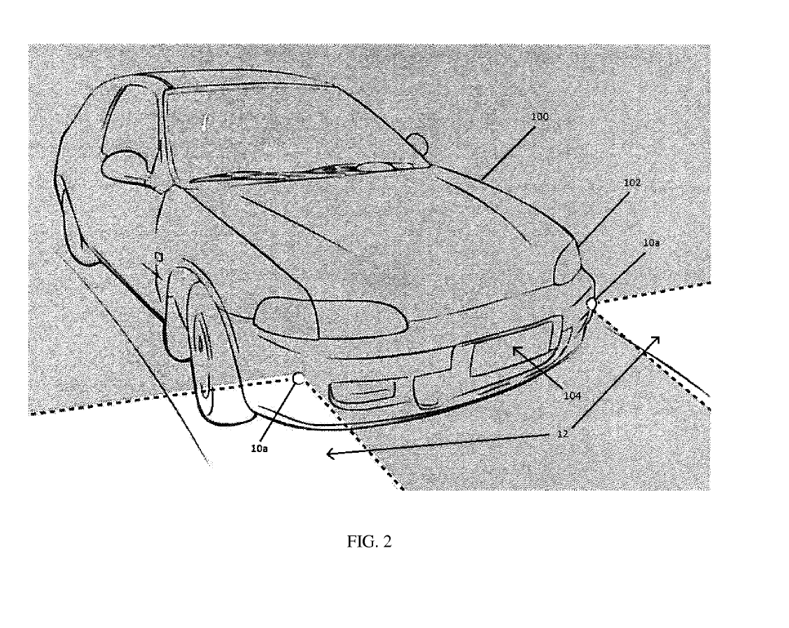

FIG. 2 shows the moving device 100 with a UV source 10a installed at or near the front of the moving device 100. In this embodiment, the UV source 10a is an active source. As used herein, an “active” source is intended to mean a light source that is powered and thus emits UV light on its own. In this embodiment, the UV source 10 a would be an electrical communication (such as with wires) with a power source (not shown) and could have an activator (not shown), such as an on-off switch, that can interrupt power to the UV source 10a so as to turn it on, or activate, the UV source 10a. When the UV source 10a, attached to the leading edge 104 of the moving device 100, is activated then UV light is emitted. Such a UV source 10 a may be a “black light” which emits long-wave UVA radiation and little visible light. Because UV light emitted from the UV source 10 appears particularly bright to deer and other animals, they tend to react sooner than to a typical headlight 102.

There are many variations in regard to the number, orientation, and location of the UV source 10a. There are two (2) UV sources 10a shown in FIG. 2, however this is not necessary. It is anticipated that there may be a single UV source 10a attached to the leading edge 104 of the moving device 100, perhaps in the center of the leading edge 104 of the moving device 100 that results in a beam 12, or beams 12, shining outwardly from the moving device 100. It is desirable that the beam 12 project forward in the direction of travel of the moving device 100 catching the attention of animals in the path of travel.

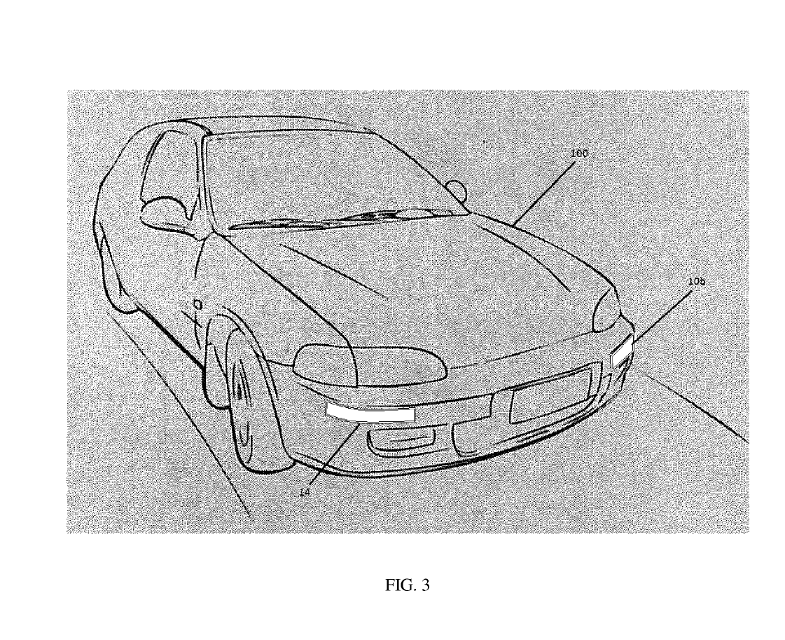

FIG. 3 shows a second embodiment in which the moving device 100 has a passive UV source 10b. As used herein, a “passive” source is intended to mean a UV source 10b that is not powered. Such passive UV sources 10b might include paints, dyes, coatings, optical brighteners, minors, and the like that specifically reflect UV light rays from an external source or emit UV light rays without the use of power. The passive UV sources 10b may be applied directly on the moving device 100, or imbued in or on an appliqué 14 that is attached to the leading edge 104 of the moving device 100. The appliqué 14 is anticipated to be made from any sort of material that may be applied for attached to the moving device 100, such as paper, vinyl, cloth, organic materials, or metals.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An apparatus for reducing collisions between a moving device and an animal comprising:
a UV light attached to a leading-edge of said moving device;
said UV light in operative communication with a power source associated with said moving device;
wherein when said UV light is connected with said power source, said UV light generates light in the UV spectrum;
wherein said light in the UV spectrum is directed outwardly and generally forward from said moving device; and
wherein said light in the UV spectrum has a wavelength in the range of 320 nm to 400 nm.
